(19) United States
(12) Patent Application Publication
(10) Pub. No.: US 2021/0387378 A1
(43) Pub. Date: Dec. 16, 2021

(54) FEEDING UNIT FOR A GEMSTONE MACHINE

(71) Applicant: Sahajanand Technologies Private Limited, Gujarat, Surat (IN)

(72) Inventors: Chirag OZA, Gujarat, Mehsana (IN); Munjal GAJJAR, Gujarat, Surat (IN); Rahul GAYWALA, Gujarat, Surat (IN)

(21) Appl. No.: 17/290,863

(22) PCT Filed: Nov. 5, 2019
(86) PCT No.: PCT/IN2019/050816

§ 371 Date: May 3, 2021

(30) Foreign Application Priority Data
Nov. 5, 2018 (IN) 201821041902

(51) Int. Cl. B28D 5/00; B24B 9/16; B24B 27/00

(52) U.S. Cl. CPC B28D 5/0064; B24B 27/0069; B24B 9/16; B28D 5/0082

(57) ABSTRACT

The feeding unit includes a base plate, and a cross member. The base plate receives the gemstones, affixed to the gemstone holders. The cross member is an automated moving member, configured such that a home position of the cross member coincides with a pre-defined point on the base plate. Accordingly, the gemstone, along with its gemstone holder, when received at the base plate is picked up by the cross member, specifically, by the first gripping member and the second gripping member, by a detachable contact established between the gemstone holder and the cross member, such that the cross member transfers the gemstone holder positioned on the base plate to a pre-defined position on the feeding unit.

### TECHNICAL FIELD

The present subject matter relates, in general, to gemstone planning and, particularly but not exclusively, to gemstone planner machines.

### BACKGROUND

Gemstones are naturally occurring deposits of minerals and can include, for example, diamonds, quartz, opals, sapphires, rubies, emeralds, and topaz. Since the gemstones are rare, they are highly valued for use. The value of these gemstones results from their color, luster, and the manner in which they transmit, refract, or reflect rays of light. For the enhancement of such properties, rough gemstones are analyzed and processed, by various techniques, such as planning by way of pre-processing and cutting, faceting, shaping, and polishing.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 schematically illustrates a gemstone planner machine for planning rough gemstones, in accordance with an embodiment of the present subject matter.

FIGS. 2 (a)-2 (i) illustrate an apparatus for transfer of a gemstone affixed to a gemstone holder in a gemstone planner machine, in accordance with another embodiment of the present subject matter.

### DETAILED DESCRIPTION

The present subject matter relates to aspects relating to automatic placement of gemstones in a gemstone planner machine.

Rough gemstones have irregular dimensions, and undergo diverse processing steps, such as planning, estimating, measuring physical attributes, sawing, bruiting, and polishing to reach to finished state.

In an embodiment, the processing steps may be performed on multiple machines, such as a gemstone planner machine, a gemstone cutting machine, and the like. The step of planning of gemstone is performed in a gemstone planner machine. The gemstone planner machine scans the rough gemstone to measure basic geometry thereof. For example, shape, dimensions (length, width, and height). Thereafter, the gemstone planner machine estimates physical attributes of the gemstone based upon the geometry of the gemstone. The physical attributes along with the rough gemstone may be transferred to the gemstone cutting machine for further cutting process.

In other embodiments, the processing steps may be performed on an integrated machine wherein different parts of the integrated machine perform the various processing steps. Accordingly, the step of planning of gemstone followed by one or more subsequent processing step may be performed within the integrated machine without having to transfer the gemstone from one machine to another. However, the gemstone may have to be moved within the integrated machine.

For example, after measurement of physical attributes of the rough gemstone in the integrated gemstone planner machine, the gemstone is affixed to a gemstone holder, and the gemstone holder along with the affixed gemstone is provided as an input to the gemstone cutting machine for further processing. In the gemstone planning step of processing, the movement of the gemstone from one stage of the integrated gemstone planner machine to another stage is carried out manually by an operator. For example, the operator picks up a gemstone with a gemstone holder from a conveyor of the integrated machine and manually carries the gemstone with the gemstone holder to a platform of the integrated machine.

Thus, in one case, the rough gemstone has to be moved from one machine to another during various processing steps, while in case of the integrated machine, the rough gemstone has to be moved from one part of the integrated machine to another. Conventionally, the transfer of a gemstone from one stage of processing to the next is dependent on human intervention and requires skilled operators to perform the transfer at different stage of the gemstone processing. Such dependencies on skilled operators is not only cost intensive but is also susceptible to human error, such as accidental dropping of the gemstones or inadvertent misplacement of the gemstones.

To this end, apparatus and method for automatic movement of gemstones affixed to gemstone holders within an integrated machine or between multiple machines that perform the various processing steps relating to gemstone processing, are described herein. The automated apparatus and method for automatic movement of the gemstones, overcome the above-described problems associated with manually transferring of the gemstones and ensure that the gemstones are correctly placed in a designated spot and no other part in or around the machines.

Various embodiments of the apparatus and method for automatic movement of gemstones described herein are presented in context of a gemstone planner machine. The described embodiments are provided as non-limiting examples of the apparatus and method for automatic movement of gemstones. It would be understood by one skilled in the art that implementations of the apparatus and method for automatic movement of gemstones in the gemstone planner machine may be extended to other machines, such as gemstone cutting machines as well.

In an embodiment, the gemstone planner machine comprises a feeding unit to receive the rough gemstones affixed to their respective gemstone holders. The gemstone holders are received by a base plate of the feeding unit. Further, the gemstone holders are transferred from the base plate to a pre-defined position on the gemstone planner machine for planning of the rough gemstone affixed onto the gemstone holder. The transfer of the gemstone holder with its respective gemstone to a pre-defined position is executed by an cross member controlled by a computing device. Thus, the user is relieved of the task of picking up the gemstone from a part of the gemstone planner machine and placing the same on another part thereof.

Thus, the present subject matter relates to the technique of transfer or placement of rough gemstones in a gemstone planner machine using an automated placement mechanism. The automated placement mechanism is controlled by the computing device, uses low-cost hardware equipment, and has limited or no manual intervention. Therefore, the gemstone transfer achieved in accordance with the techniques of the present subject matter provides a considerably accurate picking and placement of the rough gemstone onto the gemstone planner machine and involves substantially low cost in generating the finished gemstone. In other words, the gemstone planning executed in accordance with the present subject matter, achieves increase in accuracy of transfer of the rough gemstone and reduction in cost associated with the equipment used for the transfer of the gemstone.

These and other advantages of the present subject matter would be described in greater detail in conjunction with the following figures. While aspects of gemstone planning can be implemented in any number of different configurations, the embodiments are described in the context of the following device(s) and method(s).

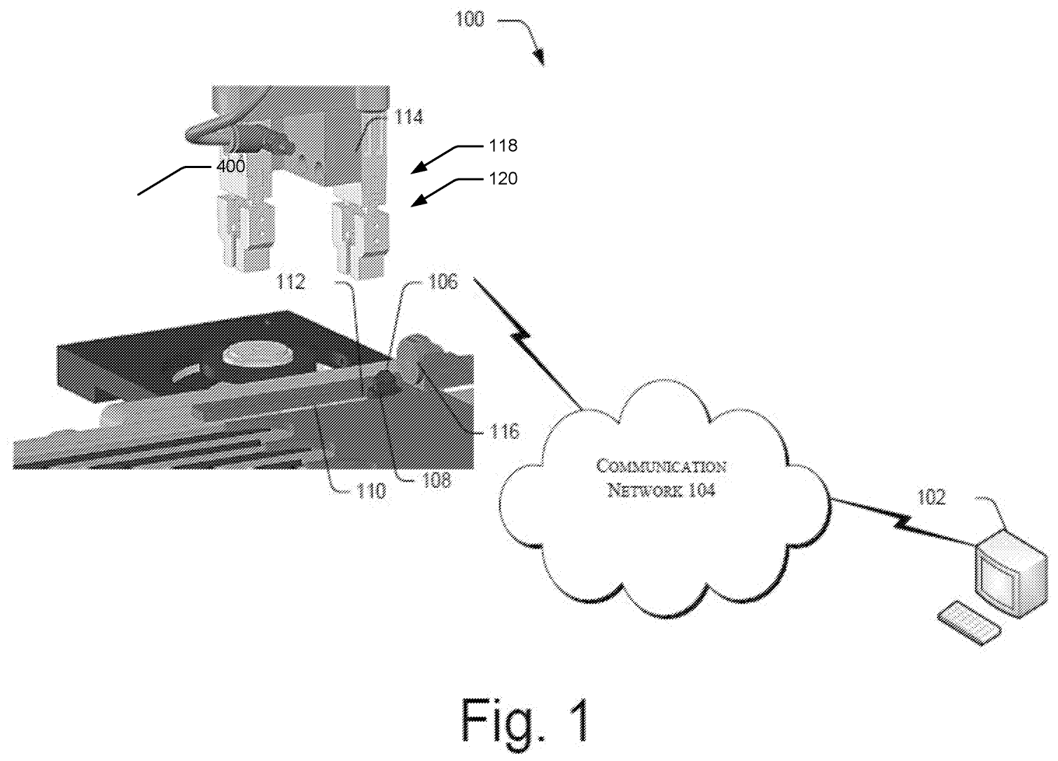

FIG. 1 illustrate schematics of a feeding unit 100 for planning rough gemstones communicatively coupled to a computing device 102 over communication network 104, in accordance with an embodiment of the present subject matter.

The feeding unit 100, according to the present subject matter, receives a rough gemstone 106 affixed to a gemstone holder 108, at a first pre-defined position to pick and transfer them to a second pre-defined position without human intervention.

In one aspect of the invention a feeding unit 100 for a gemstone machine may include a base plate 112 for receiving a plurality of gemstone holder 108 where each of the gemstone holder 108 has a gemstone 106 mounted thereto. Further, the feeding unit 100 may further include a support frame (not shown) and a delivery assembly 118. The support frame may a structure to support various components of the feeding unit 100. In an example, the support frame may be a chassis. The delivery assembly 118 may be formed to include an actuating arm 120 capable of exhibiting motion with respect to the base plate 112 and the support frame. Furthermore, the actuating arm 120 may include a central longitudinal member 110 having a distal end and a proximal end, such that the central longitudinal member 110 is movably connected to the support frame at a distal end to be movable with respect to the support frame. Moreover, the actuating arm 120 may include a cross member having a first end, a second end, a first gripping member 202 coupled at the first end, and a second gripping member 204 coupled at the second end such that the first gripping member 202 and the second gripping member 204 are each to grip a gemstone holder 108. In addition, the cross member 114 may be rotatably connected to the central longitudinal member 110 at the proximal end such that the cross member 114 is connected to the central longitudinal member 110 at a point between the first end and the second end and rotatable about an axis of the central longitudinal member 110. The feeding unit 100 may further include a processing unit (not shown) operably coupled to the delivery assembly 118. The processing unit may control movement of the central longitudinal member 110 with reference to the support frame. Further, the processing unit may control rotation of the cross member 114 to regulate position of the first gripping member 202 and the second gripping member 204 with respect to the base plate 112. In addition, the processing unit may control each of the first gripping member 202 and the second gripping member 204 to hold and release the gemstone holder 108.

In accordance with an embodiment, the arrangement of the base plate 112 is such that the base plate 112 receives the gemstones 106, affixed to the gemstone holders 108. The cross member 114 is an automated moving member, configured such that a home position of the cross member 114 coincides with a pre-defined point on the base plate 112. Accordingly, the gemstone 106, along with its gemstone holder 108, when received at the base plate 112 is picked up by the cross member 114, specifically, by the first gripping member 202 and the second gripping member 204, by a detachable contact established between the gemstone holder 108 and the cross member 114, such that the cross member 114 transfers the gemstone holder 108 positioned on the base plate 112 to a pre-defined position on the feeding unit 100.

For providing the movement to the cross member 114, the feeding unit 100 can include one or more actuators (not shown) coupled to the cross member 114. Specifically, the central longitudinal member 110 may connected to the support frame via an actuator (not shown). In addition, the cross member 114 may be connected to the central longitudinal member via an actuator. In an example, the actuator one of a tiny pager motor, a servo motor, a linear motor, a stepper motor, and a direct current (DC) geared motors, and/or an assembly including a motor and a gear box for generating an appropriate amount of torque. In addition, the actuator can include other assemblies or components that can be used for providing a movement to the central longitudinal member 110 and the cross member 114.

In an implementation, the feeding unit 100 is communicatively coupled to the computing device 102. The computing device 102 controls various function of the feeding unit 100. The computing device 102 may control assessment and planning of the gemstones 106 by the feeding unit 100. In an example, the computing device 102 may also control the movement of the cross member 114 by controlling the actuator associated with the cross member 114.

Once the gemstone 106 affixed to its gemstone holder 108, is received on the base plate 112, as explained earlier, a sensor 116 associated with the base plate 112 detects the same. Sensor data generated by the sensor 116 is communicated to the computing device 102. The computing device 102, in turn, communicates with engines associated with the actuator of the cross member 114 and the cross member 114 transfers the gemstone 106 affixed to the gemstone holder 108, from the base plate 112 to the pre-defined position.

The engines are employed as a combination of hardware and programming (for example, programmable instructions) to use functionalities of the engines. In examples described herein, such combinations of hardware and programming may be used in a number of different ways. For example, the programming for the engines may be processor executable instructions stored on a non-transitory machine-readable storage medium and the hardware for the engines may include a processing resource (for example, processors), to execute such instructions. In the present examples, the machine-readable storage medium stores instructions that, when executed by the processing resource, deploy engines. In other examples, engines may be deployed using electronic circuitry.

As explained above, the transfer of the gemstone holder 108 with its respective gemstone 106 to a pre-defined position is executed by the cross member 114 controlled by the computing device 102 instead of an operator which ultimately eliminates human dependency.

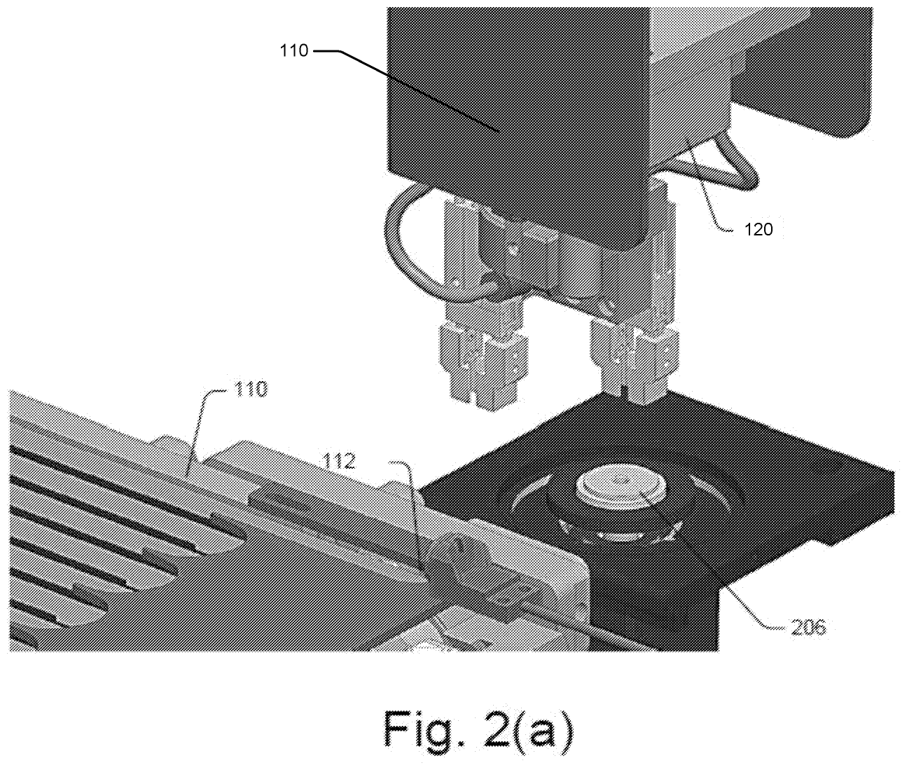

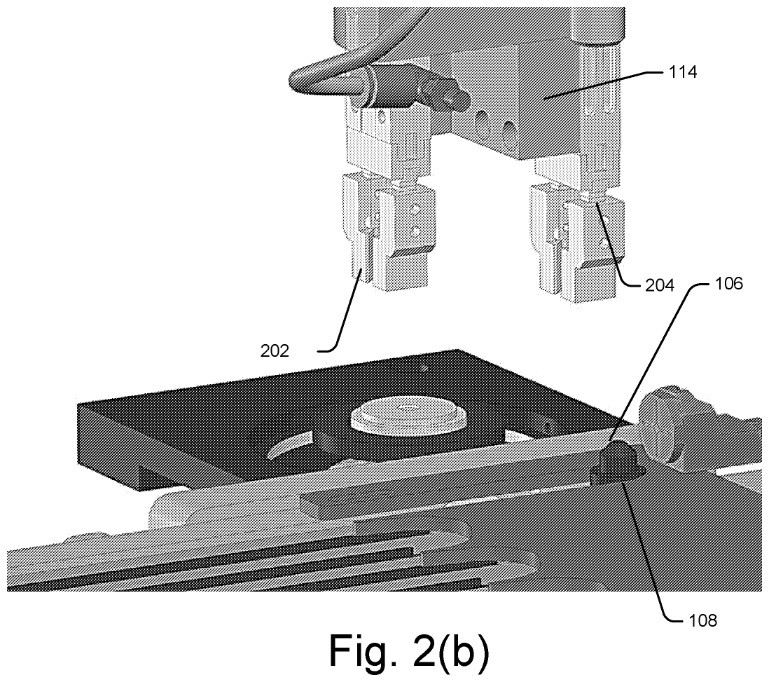

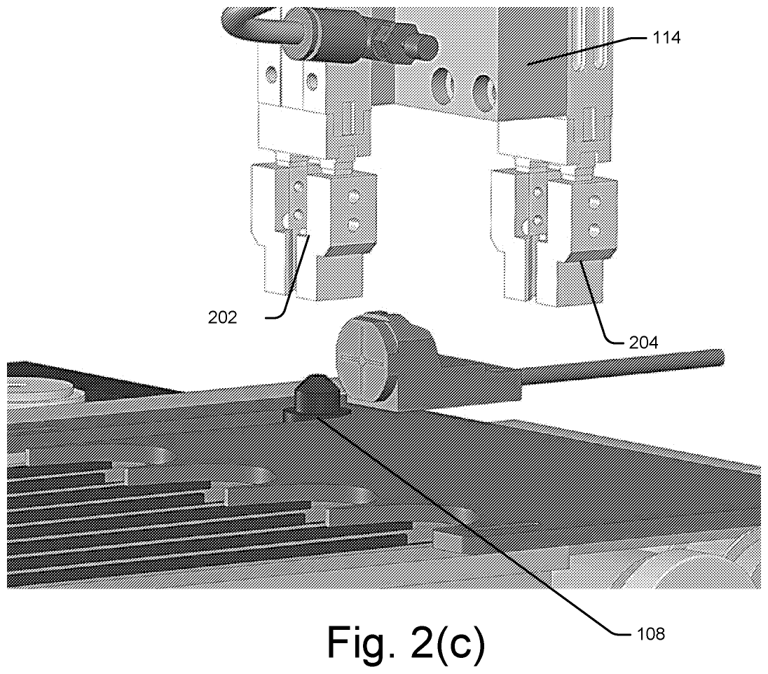

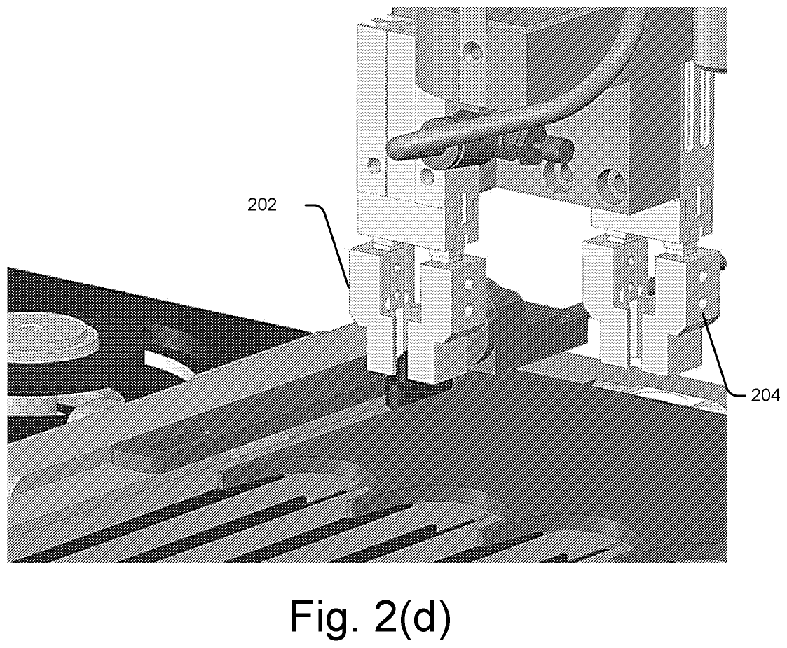

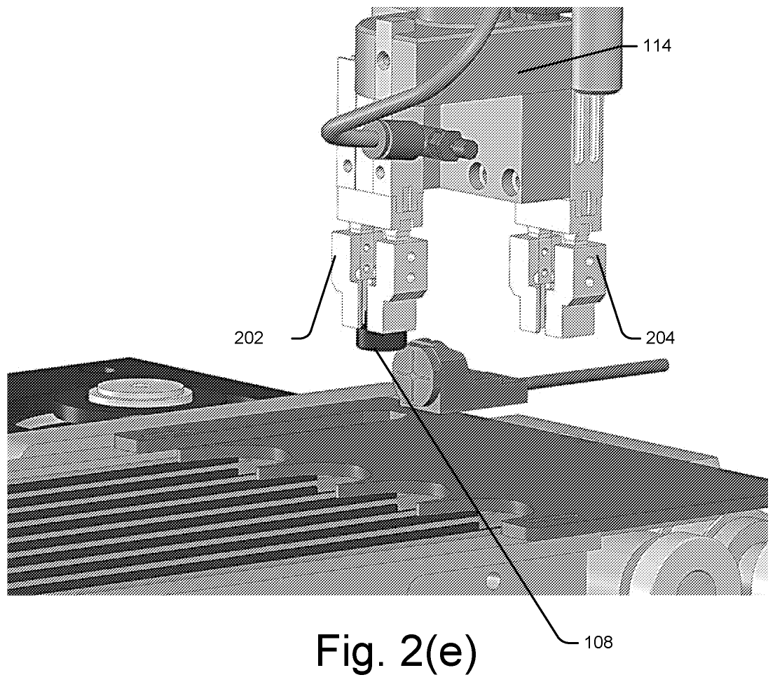

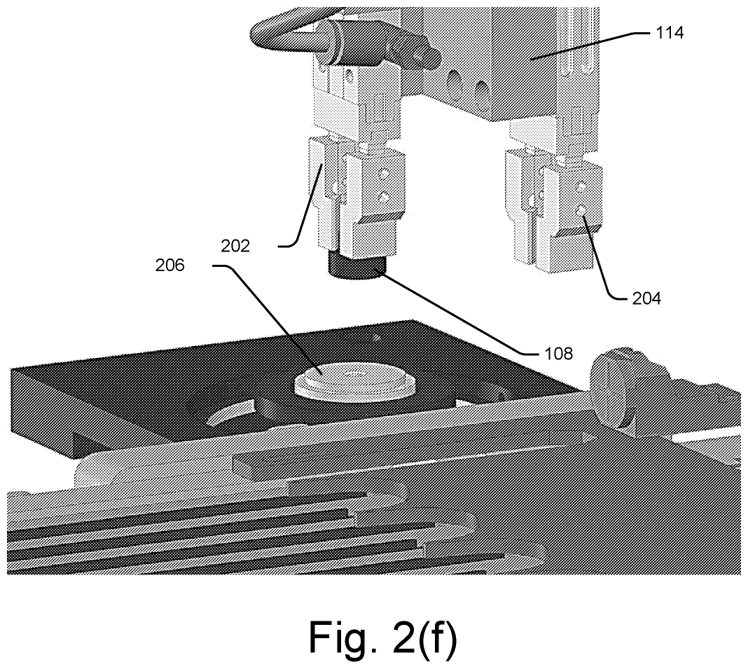

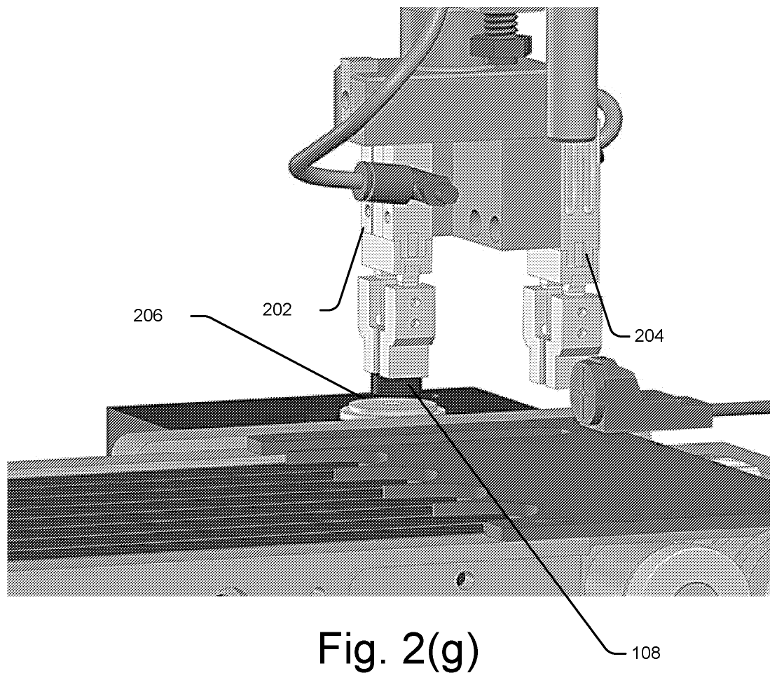

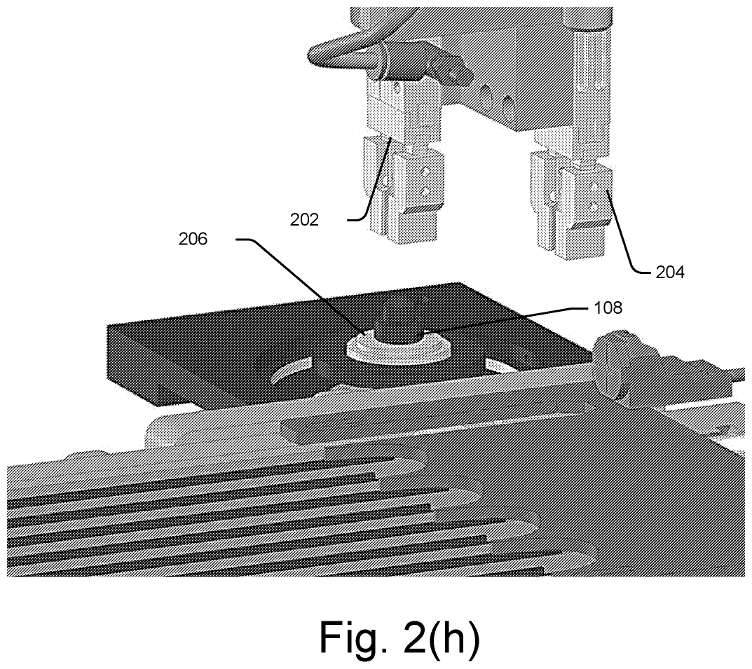

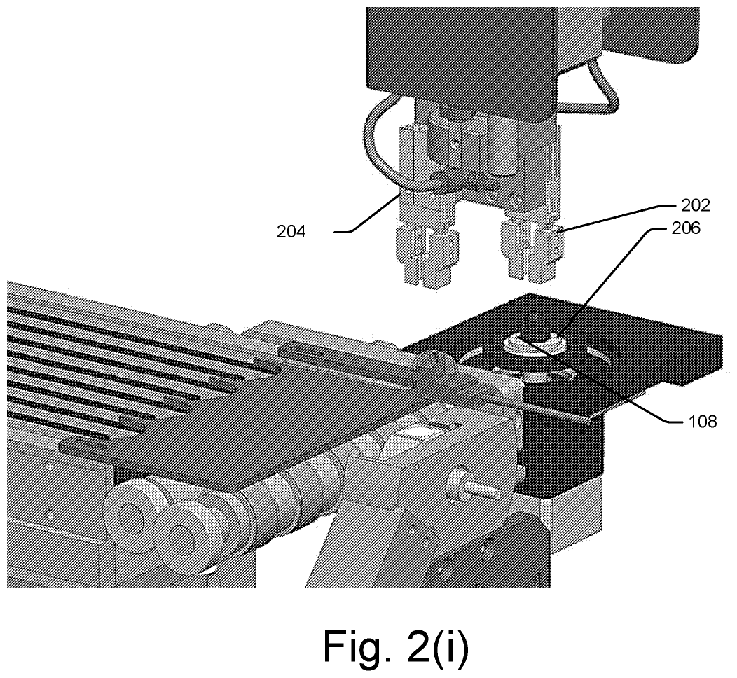

FIGS. 2 (a)-2 (i) illustrate the transfer of the gemstone 106, affixed to the gemstone holder 108, from base plate 112 to a pre-defined position by the cross member 114, in accordance with an embodiment of the present subject matter. In an example, the cross member 114 has two gripping members, referred to as a first gripping member 202 and a second gripping member 204, to detachably attach to the gemstone holder 108. In an example, each of the first gripping member 202 and the second gripping member 204 may include an electromagnet controller by the processing unit to hold and release the gemstone holder 108. Also, the gemstone holders 108 may be made of a magnetic material. Moreover, each of the first gripping member 202 and the second gripping member 204 comprises a moveable tong coupled to an actuator, wherein the actuator is controlled by the processing unit to hold and release the gemstone holder 108. In an implementation, the computing device 102 controls flow of current in the electromagnet to control the magnetic field of the electromagnet in each of the gripping member. In an example, arrangement of the first and the second gripping members 202, 204 is such that they are set at a predefined angle from each other.

In an embodiment of the present subject matter, the cross member 114 can actuate along 5 directions. In an example, the cross member 114 may actuate in 4 axes, specifically, 3 axes for linear movement and one axis for rotatory movement. The linear axis translates linear motion of the gripping members to reach desired positions along the Y-Axis. The vertical axis translates upward and downward motions of the gripping members. The rotary axis rotates the gripping members from 0 to a predefined degree at a time. In an example, the cross member 114 may exhibit a rotation of 90 degrees per movement.

FIG. 2 (a) illustrates the home position of the cross member 114 with the first gripping member 202 and the second gripping member 204. In an embodiment, upon detection of the gemstone 106 affixed to the gemstone holder 108 by the sensor 116, the cross member 114 is given command to rotate 90 degrees clockwise and move towards the base plate 112, as illustrated in FIG. 2 (b). In an example, the computing device 102 may actuate the cross member 114 along the vertical axis to pick the gemstone 106 affixed to the gemstone holder 108 from the base plate 112.

Upon alignment of the cross member 114 and the first gripping member 202 along the base plate 112, the cross member 114 moves downwards to pick the gemstone 106 affixed to the gemstone holder 108. Next, the first gripping member 202 grabs the gemstone 106 affixed to the gemstone holder 108 and moves in upwards direction. In another embodiment, the cross member 114 with the gemstone 106 affixed to the gemstone holder 108 moves towards a platform 206 of the feeding unit 100, as illustrated in FIGS. 2 (c), 2 (d), and 2 (e).

In an example, when a gemstone affixed to a gemstone holder is already present on the platform 206, upon aligning along the platform 206, the cross member 114 may rotate 90 degrees in anti-clockwise direction and after the rotation the cross member 114 moves downwards. After the rotation and the downward movement, the second gripping member 204 is aligned to the platform 206. Next, the computing device 102 may command the second gripping member 204 to pick the gemstone gemstone holder from the platform 206 of the feeding unit 100, as illustrated in FIGS. 2 (f) and 2 (g).

In an implementation, after the gemstone affixed to the gemstone holder is removed from the platform 206, the cross member 114 may rotate by 90 degrees in clockwise direction so that the first gripping member 202 aligns along the platform 206. After, the alignment of the first gripping member 202, the first gripping member 202 may be commanded by the computing device 102 to place the gemstone 106 affixed to the gemstone holder 108, picked from on the base plate 112, on the platform 206, as illustrated in FIGS. 2 (h) and 2(i).

In an exemplary embodiment of the present subject matter, after placement of the gemstone 106 affixed to the gemstone holder 108 on the platform 206, the feeding unit 100 may initiate analysis and planning of the gemstone 106. While, the gemstone 106 is analyzed by the feeding unit 100, the cross member 114 may actuate towards the base plate 112 such that the first gripping member 202 reaches at the base plate 112 to pick up the next gemstone affixed to its gemstone holder.

The automated transfer and placement mechanism elaborated in FIGS. 2 (a)-2(i) is controlled by the computing device 102 with limited or no manual intervention and uses low-cost hardware equipment. Therefore, the gemstone transfer and placement achieved in accordance with the techniques of the present subject matter provide a considerably accurate picking and placement of the rough gemstone for the feeding unit 100 and involves substantially low cost in generating the finished gemstone. Also, varying of magnetic field of the electromagnets in the gripping members of the cross member 114, by varying of the current supply by the computing device 102, would ease the transfer of heavy gemstones or gemstone holders. In other words, the gemstone processing executed in accordance with the present subject matter achieves increase in accuracy of transfer of the rough gemstone, reduction in cost associated with the equipment used for the transfer of the gemstone and increase in energy efficiency of the feeding unit 100.

In an example, the gemstone placement mechanism of the present subject matter may be used for placement of gemstones with gemstone holders in a feeding unit 100. In another example, the gemstone placement mechanism of the present subject matter may be used for placement of gemstones with gemstone holders in a gemstone cutting machine. In yet another example, the gemstone placement mechanism of the present subject matter may be used as gemstone placement mechanism in an integrated gemstone processing machine.

Although implementations for gemstone transfer and placement is described, it is to be understood that the present subject matter is not necessarily limited to the specific features of the systems or methods described herein. Rather, the specific features and methods are disclosed as implementations for gemstone transfer and placement.

1. A feeding unit for a gemstone machine, the feeding unit comprising:
a base plate for receiving a plurality of gemstone holders, each of the plurality of gemstone holders having a gemstone mounted thereto;
a support frame;
a delivery assembly comprising an actuating arm capable of exhibiting motion with respect to the base plate and the support frame, wherein the actuating arm comprises:
a central longitudinal member having a distal end and a proximal end, wherein the central longitudinal member is movably connected to the support frame at a distal end to be movable with respect to the support frame; and
a cross member having a first end, a second end, a first gripping member coupled at the first end, and a second gripping member coupled at the second end, wherein the first gripping member and the second gripping member are each to grip a gemstone holder, wherein the cross member is rotatably connected to the central longitudinal member at the proximal end thereof, wherein the cross member is connected to the central longitudinal member at a point between the first end and the second end and rotatable about an axis of the central longitudinal member; and a processing unit operably coupled to the delivery assembly to,
control movement of the central longitudinal member with reference to the support frame;
control rotation of the cross member to regulate position of the first gripping member and the second gripping member with respect to the base plate; and
control each of the first gripping member and the second gripping member to hold and release the gemstone holder.

2. The feeding unit as claimed in claim 1, wherein the central longitudinal member is connected to the support frame via an actuator.

3. The feeding unit as claimed in claim 1, wherein the cross member is connected to the central longitudinal member via an actuator.

4. The feeding unit as claimed in claim 1, wherein each of the first gripping member and the second gripping member comprises an electromagnet controller by the processing unit to hold and release the gemstone holder.

5. The feeding unit as claimed in claim 1, wherein each of the first gripping member and the second gripping member comprises a moveable tong coupled to an actuator, wherein the actuator is controlled by the processing unit to hold and release the gemstone holder.

6. The feeding unit as claimed in claim 1, wherein the actuator is one of a tiny pager motor, a servo motor, a linear motor, a stepper motor, and a direct current (DC) geared motors.

7. The feeding unit as claimed in claim 1, wherein the cross member is to exhibit a rotation of 90 degrees per movement.

8. A feeding unit for a gemstone machine, the feeding unit comprising:
a base plate for receiving a plurality of gemstone holders, each of the plurality of gemstone holders having a gemstone mounted thereto;
a delivery assembly comprising an actuating arm capable of exhibiting motion with respect to the base plate, wherein the actuating arm comprises:
a central longitudinal member movably connected to the support frame at one end; and
a cross member having a first end, a second end, a first gripping member coupled at the first end, and a second gripping member coupled at the second end, wherein the first gripping member and the second gripping member are each to grip a gemstone holder and are fixedly positioned with respect to each other, the cross member being transversely connected to another end of the central longitudinal member along and being rotatable about an axis of the central longitudinal member; and a processing unit operably coupled to the delivery assembly to,
control movement of the central longitudinal assembly with reference to the support frame;
control rotation of the cross member to regulate position of the first gripping member and the second gripping member with respect to the base plate, wherein the cross member is to exhibit a rotation of 90 degrees per movement; and
control each of the first gripping member and the second gripping member to hold and release the gemstone holder.

9. The feeding unit as claimed in claim 8, wherein the central longitudinal member is connected to the support frame via an actuator.

10. The feeding unit as claimed in claim 8, wherein the cross member is connected to the central longitudinal member via an actuator.

11. The feeding unit as claimed in claim 8, wherein each of the first gripping member and the second gripping member comprises an electromagnet controller by the processing unit to hold and release the gemstone holder.

12. The feeding unit as claimed in claim 8, wherein each of the first gripping member and the second gripping member comprises a moveable tong coupled to an actuator, wherein the actuator is controlled by the processing unit to hold and release the gemstone holder.

13. The feeding unit as claimed in claim 9, wherein the actuator is one of a tiny pager motor, a servo motor, a linear motor, a stepper motor, and a direct current (DC) geared motors.
